(19) United States
(12) Patent Application Publication
(10) Pub. No.: US 2010/0199036 A1
(43) Pub. Date: Aug. 5, 2010

(54) SYSTEMS AND METHODS FOR BLOCK-LEVEL MANAGEMENT OF TIERED STORAGE

(75) Inventors: Samuel Burk Siewert, Erie, CO (US); Nicholas Martin Nielsen, Erie, CO (US); Phillip Clark, Boulder, CO (US); Lars E. Boehnke, Firestone, CO (US)

Correspondence Address: HOLLAND & HART, LLP, P.O BOX 8749, DENVER, CO, 80201, US

(73) Assignee: ATRATO, INC., Westminster, CO (US)

(21) Appl. No.: 12/364,271

(22) Filed: Feb. 2, 2009

(51) Int. Cl. G06F 12/02; G06F 12/00

(52) U.S. Cl. 711/112; 711/114; 711/165; 711/E12.001; 711/E12.002

(57) ABSTRACT

Acceleration of I/O access to data stored on large storage systems is achieved through multiple tiers of data storage. An array of first storage devices with relatively slow data access rates, such as hard disk drives, is provided along with a smaller number of second storage devices having relatively fast data access rates, such as solid state disks. Data is moved from the first storage devices to the second storage devices to improve data access time based on applications accessing the data and data access patterns.

### FIELD

The present disclosure is directed to tiered storage of data based on access patterns in a data storage system, and, more specifically, to tiered storage of data based on a feature vector analysis and multi-level binning to identify most frequently accessed data.

### BACKGROUND

Network-based data storage is well known, and may be used in numerous different applications. One important metric for data storage systems is the time that it takes to read/write data from/to the system, commonly referred to as access time, with faster access times being more desirable. One or more network based storage devices may be arranged in a storage area network (SAN) to provide centralized data sharing, data backup, and storage management in networked computer environments. Network storage devices are used to refer to any device that principally contains a single disk or multiple disks for storing data for a computer system or computer network. Because these storage devices are intended to serve several different users and/or applications, these storage devices are typically capable of storing much more data than the hard drive of a typical desktop computer. The storage devices in a SAN can be co-located, which allows for easier maintenance and easier expandability of the storage pool. The network architecture of most SANs is such that all of the storage devices in the storage pool are available to all the users or applications on the network, with the relatively straightforward ability to add additional storage devices as needed.

The storage devices in a SAN may be structured in a redundant array of independent disks (RAID) configuration. When a system administrator configures a shared data storage pool into a SAN, each storage device may be grouped together into one or more RAID volumes and each volume is assigned a SCSI logical unit number (LUN) address. If the storage devices are not grouped into RAID volumes, each storage device will typically be assigned its own LUN. The system administrator or the operating system for the network will assign a volume or storage device and its corresponding LUN to each server of the computer network. Each server will then have, from a memory management standpoint, logical ownership of a particular LUN and will store the data generated from that server in the volume or storage device corresponding to the LUN owned by the server.

A RAID controller is the hardware element that serves as the backbone for the array of disks. The RAID controller relays the input/output (I/O) commands or read/write requests to specific storage devices in the array as a whole. RAID controllers may also cache data retrieved from the storage devices. RAID controller support for caching may improve the I/O performance of the disk subsystems of the SAN. RAID controllers generally use read caching, read-ahead caching or write caching, depending on the application programs used within the array. For a system using read-ahead caching, data specified by a read request is read, along with a portion of the succeeding or sequentially related data on the drive. This succeeding data is stored in cache memory on the RAID controller. If a subsequent read request uses the cached data, access to the drive is avoided and the data is retrieved at the speed of the system I/O bus rather than the speed of reading data from the disk(s). Read-ahead caching is known to enhance access times for systems that store data in large sequential records, is ill-suited for random-access applications, and may provide some benefit for situations that are not completely random-access. In random-access applications, read requests are usually not sequentially related to previous read requests.

It is also known for RAID controllers to also use write caching. Write-through caching and write-back caching are two distinct types of write caching. For systems using write-through caching, the RAID controller does not acknowledge the completion of the write operation until the data is written to drives. In contrast, write-back caching does not copy modifications to data in the cache to the cache source until absolutely necessary. The RAID controller signals that the write request is complete after the data is stored in the cache but before it is written to the drive. The caching method improves performance relative to write-through caching because the application program can resume while the data is being written to the drive. However, there is a risk associated with this caching method because if system power is interrupted, any information in the cache may be lost.

Most RAID systems provide I/O cache at a block level and employ traditional cache algorithms and policies such as LRU replacement (Least Recently Used) and set associative cache maps between storage LBA (Logical Block Address) ranges. To improve cache hit rates on random access workloads, RAID controllers typically use cache algorithms developed for processors, such as those used in desktop computers. Processor cache algorithms generally rely on the locality of reference of their applications and data to realize performance improvements. As data or program information is accessed by the computer system, this data is stored in cache in the hope that the information will be accessed again in a relatively short time. Once the cache is full, an algorithm is used to determine what data in cache should be replaced when new data that is not in cache is accessed. Because processor activities normally have a high degree of locality of reference, this algorithm works relatively well for local processors.

However, secondary storage I/O activity rarely exhibits the degree of locality for accesses to processor memory, resulting in low effectiveness of processor based caching algorithms if used for RAID controllers. The use of a RAID controller cache that uses processor based caching algorithms may actually degrade performance in random access applications due to the processing overhead incurred by caching data that will not be accessed from the cache before being replaced. As a result, conventional caching methods are not effective for storage applications. Some storage subsystems vendors increase the size of the cache in order to improve the cache hit rate. However, given the associated size of the SAN storage devices, increasing the size of the cache may not significantly improve cache hit rates. For example, in the case where 512 MB cache is connected to twelve 500 GB drives, the cache is only 0.008138% the size of the associated storage. Even if the cache size is doubled (or tripled), increasing the cache size will not significantly increase the hit ratio because the locality of reference for these systems is low.

### SUMMARY

Embodiments disclosed herein enhance data access times by providing tiered data storage systems, methods, and apparatuses that enhance access to data stored in arrays of storage devices based on access patterns of the stored data.

In one aspect, provided is a data storage system comprising (a) a plurality of first storage devices each having a first average access time, the storage devices having data stored thereon at addresses within the first storage devices, (b) at least one second storage device having a second average access time that is shorter than the first average access time, (c) a storage controller that (i) calculates a frequency of accesses to data stored in coarse regions of addresses within the first storage devices, (ii) calculates a frequency of accesses to data stored in fine regions of addresses (e.g. set of LBAs) within highly accessed coarse regions of addresses, and (iii) copies highly accessed fine regions of addresses to the second storage device(s). The first storage devices may comprise a plurality of hard disk drives, and the second storage devices may comprise one or more solid state memory device(s). The coarse regions of addresses are ranges of logical block addresses (LBAs) and the number of LBAs in the coarse regions is tunable based upon the accesses to data stored at said first storage devices. The fine regions of addresses are ranges of LBAs within each coarse region, and the number of LBAs in fine regions is tunable based upon the accesses to data stored in the coarse regions. In some embodiments the storage controller further determines when access patterns to the data stored in coarse regions of addresses have changed significantly and recalculates the number of addresses in the fine regions. Feature vector analysis mathematics can be employed to determine when access patterns have changed significantly based on normalized counters of accesses to coarse regions of addresses. The data storage system, in some embodiments also comprises a look-up table that indicates blocks in coarse regions that are cached and in response to a request to access data, determines if the data is stored in said cache and provides data from the cache if the data is found in the cache. The look-up table may comprise an array of elements, each of which having an address detail pointer, or may comprise two-levels, a single pointer value of non-zero indicating that a coarse region has cached addresses and a second address detail pointer.

Another aspect of the present disclosure provides a method for storing data in a data storage system, comprising: (1) calculating a frequency of accesses to data stored in coarse regions of addresses within a plurality of first storage devices, the first storage devices having a first average access time; (2) calculating a frequency of accesses to data stored in fine regions of addresses within highly accessed coarse regions of addresses; and (3) copying highly accessed fine regions of addresses to one or more of a plurality of second storage devices, the second storage devices having a second average access time that is shorter than the first average access time. The plurality of first storage devices, in an embodiment, comprise a plurality of hard disk drives and the second storage devices comprise solid state memory devices. The coarse regions of addresses, in an embodiment, are ranges of logical block addresses (LBAs) and the calculating a frequency of accesses to data stored in coarse regions comprises tuning the number of LBAs in the coarse regions based upon the accesses to data stored at the first storage devices. In another embodiment the coarse regions of addresses are ranges of logical block addresses (LBAs) and the fine regions of addresses are ranges of LBAs within each coarse region, and the calculating a frequency of accesses to data stored in fine regions comprises tuning the number of LBAs in fine regions based upon the accesses to data stored in the coarse regions. The method further includes, in some embodiments, determining that access patterns to the data stored in the second plurality of storage devices have changed significantly, identifying least frequently accessed data stored in the second plurality of storage devices, and replacing the least frequently accessed data with data from the first plurality of storage devices that is accessed more frequently.

A further aspect of the disclosure provides a data storage system, comprising: (1) a plurality of first storage devices that have a first average access time and that store a plurality of virtual logical units (VLUNs) of data including a first VLUN; (2) a plurality of second storage devices that have a second average access time that is shorter than the first average access time; and (3) a storage controller comprising: (a) a front end interface that receives I/O requests from at least a first initiator; (b) a virtualization engine having an initiator-target-LUN (ITL) module that identifies initiators and VLUN(s) accessed by each initiator, and (c) a tier manager module that manages data that is stored in each of said plurality of first storage devices and said plurality of second storage devices. The tier manager identifies data that is to be moved from said first VLUN to said second plurality of storage devices based on access patterns between the first initiator and data stored at the first VLUN. The virtualization engine may also include an ingest reforming and egress read-ahead module that moves data from said the VLUN to the plurality of second storage devices when the first initiator accesses data stored at the first VLUN, the data moved from the first VLUN to the plurality of second storage devices comprising data that is stored sequentially in the first VLUN relative to the accessed data. The ITL module, in some embodiments, enables or disables the tier manager for specific initiator/LUN pairs, and enables or disables the ingest reforming and egress read-ahead module for specific initiator/LUN pairs. The ITL module can enable or disable the tier manager and ingest reforming and egress read-ahead module based on access patterns between specific initiators and LUNs.

### BRIEF DESCRIPTION OF THE DRAWINGS

Various embodiments, including preferred embodiments and the currently known best mode for carrying out the invention, are illustrated in the drawing figures, in which:

FIG. 1 is an illustration of a spectrum of predictability of data accessed in a data storage system;

FIG. 2 is a block diagram illustration of a system of an embodiment of the disclosure;

FIG. 3 is a block diagram illustration of a storage controller of an embodiment of the disclosure;

FIG. 4A is a block diagram of traditional RAID-5 data storage;

FIG. 4B is a block diagram of RAID-5 data storage according to an embodiment of the disclosure;

FIG. 5 is a block diagram illustration of RAID-6 data storage according to an embodiment of the disclosure;

FIG. 6A and FIG. 6B are block diagram illustrations of data storage on tier-0 VLUNs according to an embodiment of the disclosure;

FIG. 7 is an illustration of a long-tail distribution of content access of a storage system;

FIG. 8 is an illustration of hot-spots of highly accessed content in a data storage array;

FIG. 9 is an illustration of a look-up table of data that is stored in a tier-0 memory cache;

FIG. 10 is an illustration of a system that provides a write-back cache for applications writing data to RAID storage; and

FIGS. 11-15 are illustrations of a system that provides tier-0 storage based on specific initiator-target-LUN nexus mapping.

### DETAILED DESCRIPTION

The present disclosure provides for efficient data storage in a relatively large storage system, such as a system including an array of drives having capability to store petabytes of data. In such a system, accessing desired data with acceptable quality of service (QoS) can be a challenge. Aspects of the present disclosure provide systems and methods to accelerate I/O access to the terabytes of data stored on such large storage systems. In embodiments described more fully below, a RAID array of Hard Disk Drives (HDDs) is provided along with a smaller number of Solid State Disks (SSDs). Note that SSDs include flash-based SSDs and RAM-based SSDs since systems and methods described herein can be applied to any SSD device technology. Likewise, systems and methods described herein may be applied to any configuration in which relatively high data rate access devices (referred to herein as “tier-0 devices” or “tier-0 storage”) are coupled with relatively slower data rate devices to provide two or more tiers of data storage. For example, high data rate access devices may include flash-based SSD, RAM-based SSD, or even high performance SAS HDDs, as long as the tier-0 storage has significantly better access performance compared to the other storage devices of the system. In systems having three or more tiers of data storage, each tier has significantly better access performance compared to higher-level tiers. It is contemplated that tier-0 devices in many embodiments will have at least 4-times the access performance of the other storage elements in the storage array, although advantages may be realized in situations where the relative access performance is less than 4×. For example, in an embodiment a flash-based SSD is used for tier-0 storage and has about 1000 times faster access than HDDs that are used for tier-1 storage.

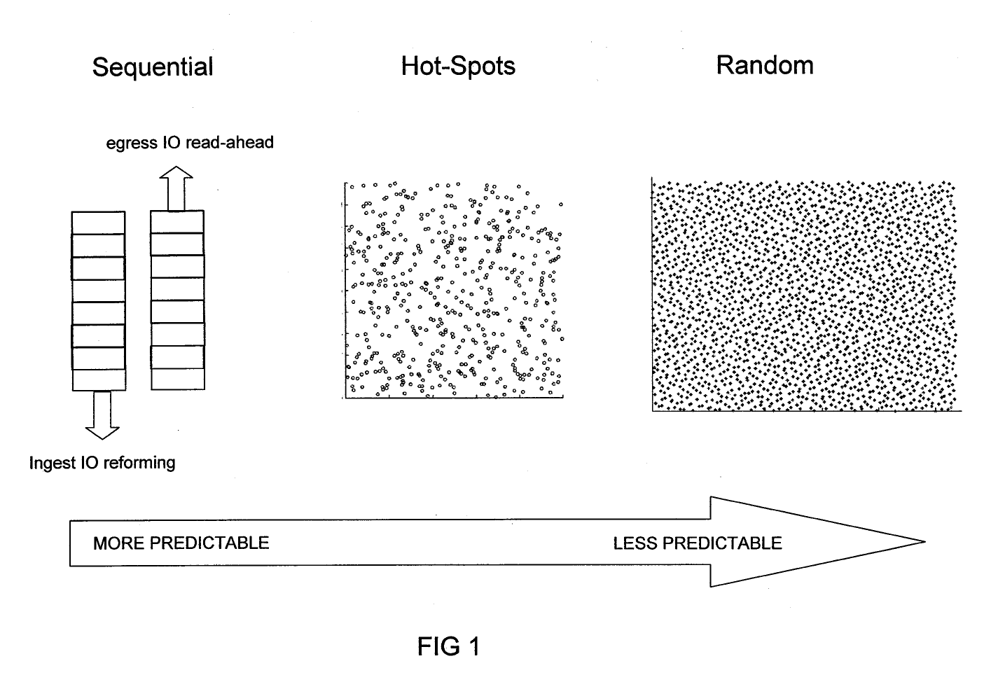

In various embodiments, data access may be improved in configurations using tier-0 storage using various different techniques, alone or in combination depending upon particular applications in which the storage system is used. In such embodiments, access patterns are identified, such as access patterns that are typical for an application that is using the storage system (referred to herein as “application aware”). Such access patterns have a spectrum that range from very predictable access such as data being written to or read from sequential LBAs, to not predictable at all such as I/O requests to random LBAs. In some cases, access patterns may be semi-predictable in that hot spots can be detected in which the LBAs in the hot spots are accessed with a higher frequency. FIG. 1 illustrates such a spectrum of accesses to storage, the leftmost portion of this Figure illustrating a scenario with highly predictable sequential access patterns, in which egress I/O read-ahead and ingest I/O reforming may be used to enhance access times. Illustrated in the middle of the spectrum of FIG. 1 is an illustration of hot spots or areas of data stored in a storage array that have relatively high frequencies of access. Illustrated on the right of FIG. 1 is a least predictable access pattern in which areas of storage in a storage array are accessed at random or nearly at random. Various access patterns may be more likely for different applications that are using the storage system, and in embodiments of this disclosure the storage system is aware, or capable of becoming aware, of applications that are accessing the storage system and capable of moving certain data to a lower-level tier of data storage such that access times for the data may be improved. For example, an application aware storage system may recognize that an application is likely to have a sequential access pattern, and based on an I/O from the application perform read-ahead caching of stored data. Similarly, an application aware storage system may recognize hot spots of high-frequency data accesses in a storage array, and move data associated with the hot spot areas into a lower tier of data storage to improve access times for such data.

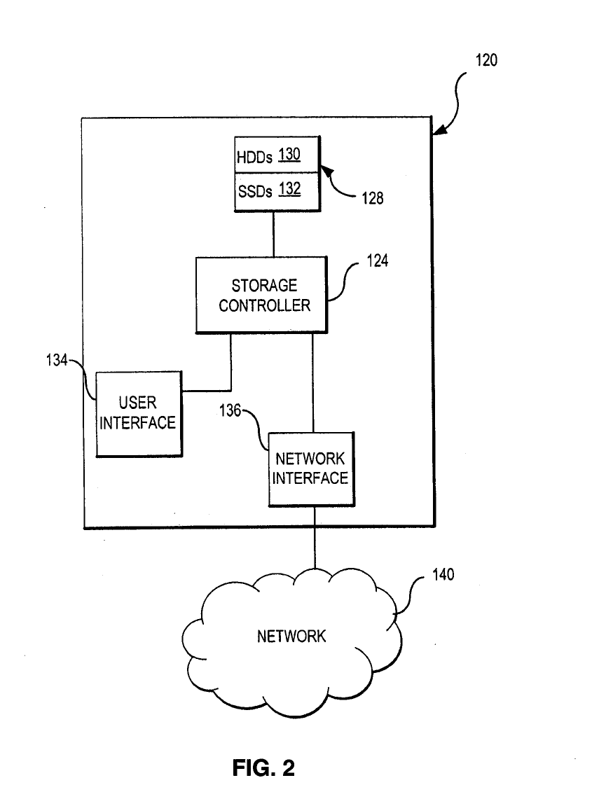

With reference now to FIG. 2, a block diagram of a storage system of an embodiment is illustrated. The storage system 120 includes a storage controller 124, a storage array 128. The storage array 128 includes an array of hard disk drives (HDDs) 130, and solid state storage such as solid state disks (SSDs) 132. The HDDs 130 in this embodiment are operated as a RAID storage, and the storage controller 124 includes a RAID controller. The SSDs 132 are solid state disks that are arranged as tier-0 data storage for the storage controller 124. While SSDs are discussed herein, it will be understood that this storage may include devices other than or in addition to solid state memory devices. A local user interface 134 is optional and may be as simple as include one or more status indicators indicating that the system 120 has power and is operating, or a more advanced user interface providing a graphical user interface for management of storage functions of the storage system 120. A network interface 136 interfaces the storage controller 124 with an external network 140.

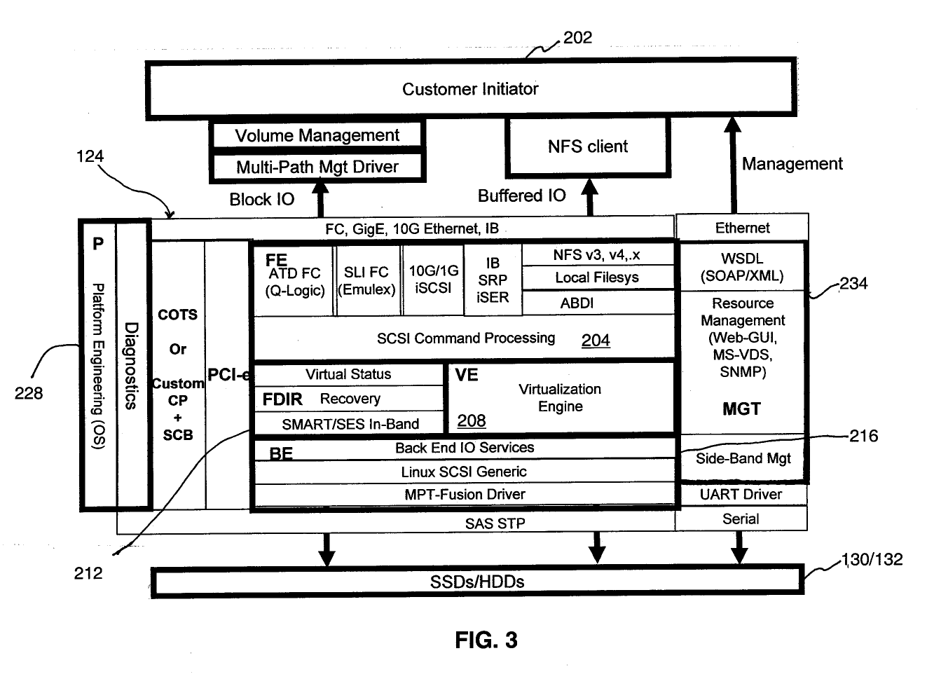

FIG. 3 illustrates an architecture stack for a storage system of an embodiment. In this embodiment, the storage controller 124 receives block I/O and buffered I/O from a customer initiator 202 into a front end 204. The I/O may come into the front end 204 using any of a number of physical transport mechanisms, including fiber channel, gigabit Ethernet, 10G Ethernet, and Infiniband, to name but a few. I/Os are received by the front end 204 and provided to a virtualization engine 208, and to a fault detection, isolation, and recovery (FDIR) module 212. A back end 216 is used to communicate with the storage array that includes HDDs 130 and SSDs 132 as described with respect to FIG. 2. A management interface 234 may be used to provide management functions, such as a user interface and resource management to the system. Finally, a diagnostics engine 228 may be used to perform testing and diagnostics for the system.

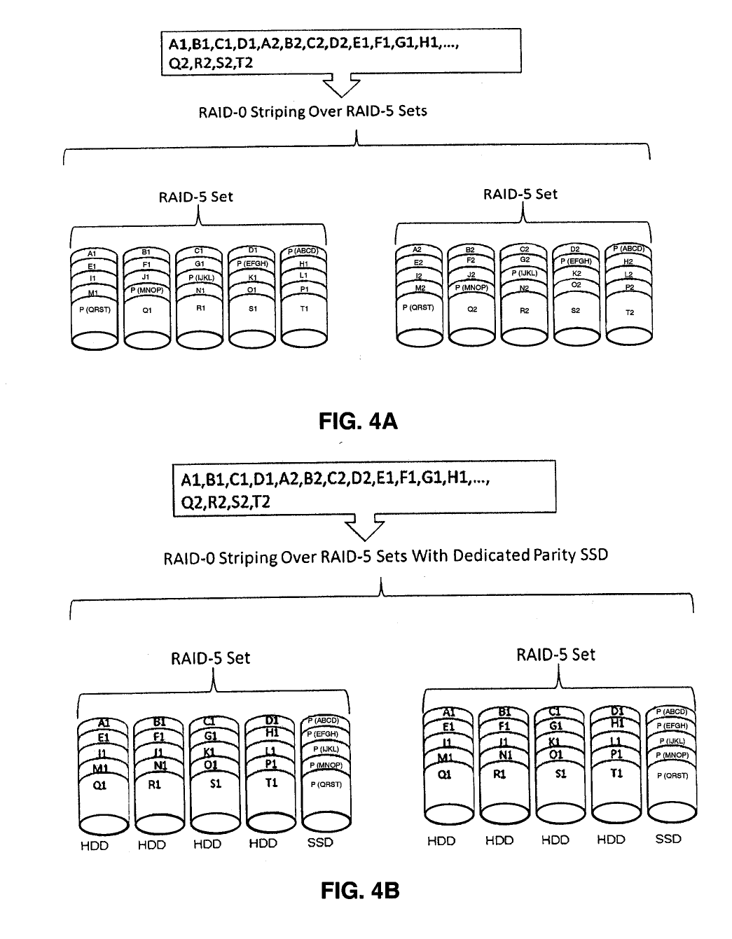

As described above, the incorporation of tier-0 storage into storage systems such as those of FIGS. 2 and 3 can provide enhanced data access times for data that is stored at the systems. One type of data access acceleration is achieved through RAID-5/50 acceleration by mapping data as RAID-4/40 data and using a dedicated SSD parity drive. FIG. 4A illustrates a traditional RAID-5/50 system, and FIG. 4B illustrates a system in which a dedicated parity drive (SSD) is implemented. In this embodiment, data is stored using traditional and well known RAID 5 techniques in which data is stored across multiple devices in stripes, with a parity block included for each stripe. In the event that one of the devices fails, the data on the other devices may be used to recover the data from the failed device, and there is no loss of data in the event of such a failure. FIGS. 4A and 4B illustrate mirrored RAID5 sets. In FIG. 4B, the parity for each stripe is stored on a SSD. Using traditional RAID techniques and storage, such data storage techniques incur what is widely known as a “write penalty” associated with RAID-5 read-modify-write updates required when transactions are not perfectly strided for the RAID-5 set. In this embodiment, data access is accelerated by mapping a dedicated SSD to parity block storage, which significantly reduces the “write penalty.” Performance increases in some applications may be significantly improved by using such a dedicated parity storage. In one embodiment, the tier-0 storage is 7 % of the capacity of the HDD (or non-tier-0) capacity, and provides write performance increases of up to 50%.

In one specific application of the embodiment of FIGS. 4A and 4B, all of the parity blocks for a RAID-5 set, which may be striped for RAID-50, are mapped to an SSD. Speedup using this mapping was demonstrated using the MDADM open source software to provide a RAID-5 mapping in Linux 2.6.18 and showed speed-up for reads and writes that ranged from 10 to 50% compared to striped mapping of parity. In general, a dedicated parity drive is considered a RAID-4 mapping and has always suffered a write-penalty because the dedicated parity drive becomes a bottleneck. In the case of a dedicated parity SSD, the SSD is not a bottleneck and provides speed-up by offloading parity reads/writes from the HDDs in the RAID set. The below tables summarize three different tests that were conducted for such a dedicated SSD parity drive:

TABLE 1
Test 1
Array of 16 HDDs in RAID 4 config (32K chunk)
iozone -R -s1G -r49K -t 16 -T -i0 -i2

| Initial write | Rewrite | Random read | Random write |
|---|---|---|---|
| 42540 KB/s | 42071 KB/s | 25800 KB/s | 5249 KB/s |

TABLE 2
Test 2
Array of 15 HDDs with SSD parity in RAID 4 config (32K chunk)
iozone -R -s1G -r49K -t 16 -T -i0 -i2

| Initial write | Rewrite | Random read | Random write |
|---|---|---|---|
| 56368 KB/s | 41507 KB/s | 26120 KB/s | 12687 KB/s |

TABLE 3
Test 3
Array of 16 HDDs with RAID 5 config (32K chunk)
iozone -R -s1G -r49K -t 16 -T -i0 -i2

| Initial write | Rewrite | Random read | Random write |
|---|---|---|---|
| 50354 KB/s | 35703 KB/s | 17441 KB/s | 8342 KB/s |

As illustrated in this specific example, performance for RAID-5/50 with dedicated SSD parity drive (RAID-4) may be summarized as: RAID-4+SSD parity compared to RAID-5 HDD provides a 10% to 50% Performance Improvement; Sequential Write provides 56 MB/sec vs. 50 MB/sec; Random Read provides 26 MB/sec vs. 17.4 MB/sec; and Random Write provides 12 MB/sec vs. 8 MB/sec. The process of using RAID-4 with dedicated SSD parity drive instead of RAID-5 with all HDDs provides the equivalent data protection of RAID-5 with all HDDs and improves performance significantly by reducing write-penalty associated with RAID-5.

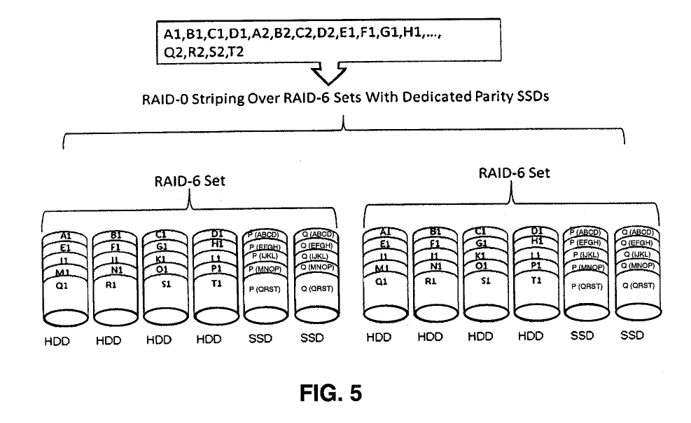

The concept of FIG. 4B may also be applied to RAID-6/60 such that the Galois P,Q parity blocks are mapped to two dedicated SSDs and the data blocks to N data HDDs in an N+2 RAID-6 set mapping. Such an embodiment is illustrated in FIG. 5.

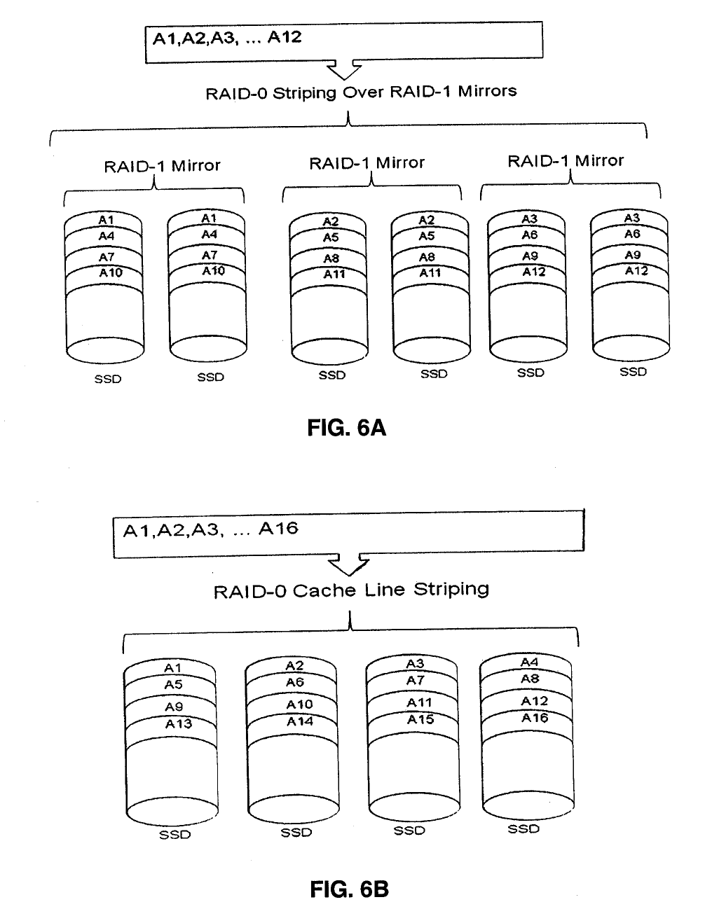

Another technique that may be implemented in a system having a tier-0 storage is through a tier-0 VLUN. In one embodiment, illustrated in FIGS. 6A and 6B, VLUNs can be created with SSD storage for specific application data such as filesystem metadata, VoD trick play files, highly-popular VoD content, or any other known higher access rate data for applications. As illustrated in FIG. 6A, an SSD VLUN is simply a virtual LUN that is mapped to a drive pool of SSDs instead of HDDs in a RAID array. This mapping allows applications to map data that is known to have high access rates to the faster (higher I/O operations per second and bandwidth) SSDs. This allows filesystems to dedicate metadata for directory structure, journals, and file-level RAID mappings to faster access SSD storage. It also allows an operator to map known high access content to an SSD VLUN on an VoD (Video on Demand) server. In general, the SSD VLUN has value for any application where high access content is known in advance.

In another embodiment, data access in improved using tier-0 high access block storage. As discussed above, many I/O access patterns for disk subsystems exhibit low levels of locality. However, while many applications exhibit what may be characterized as random I/O access patterns, very few applications truly have completely random access patterns. The majority of data most applications access are related and, as a result, certain areas of storage are accessed with relatively more frequency than other areas. The areas of storage that are more frequently accessed than other areas may be called “hot spots.” For example, index tables in database applications are generally more frequently accessed than the data store of the database. Thus, the storage areas associated with the index tables for database applications would be considered hot spots, and it would be desirable to maintain this data in higher access rate storage. However, for storage I/O, hot spot references are usually interspersed with enough references to non-hot spot data such that conventional cache replacement algorithms, such as LRU algorithms, do not maintain the hot spot data long enough to be re-referenced. Because conventional caching algorithms used by RAID controllers do not attempt to identify hot spots, these algorithms are not effective for producing a large number of cache hits.

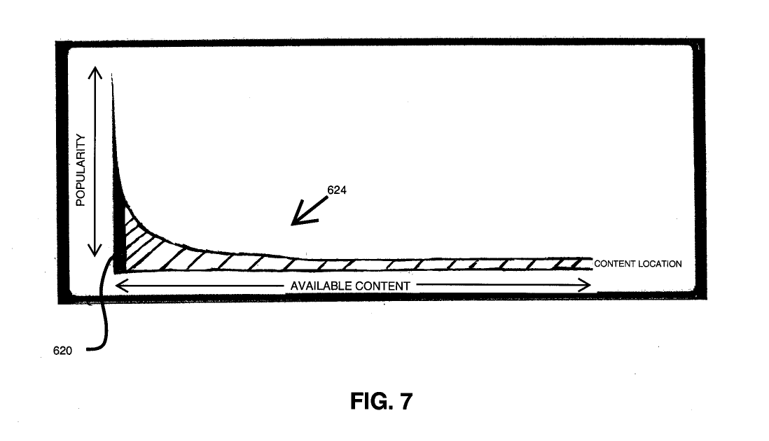

With reference now to FIG. 7, access to large bodies of content has been shown to follow a “Long Tail” access pattern, making traditional I/O cache algorithms relatively ineffective. The reason is that the head of the tail 620 shown in FIG. 7 most likely will exceed RAM cache available in a typical RAID controller. Furthermore, access to long tail content 624 may have unacceptable access times, leading to poor QoS. The present disclosure recognizes that through migration of data from spinning media disk to a SSD, this reduces the access request backlog to the spinning media to perform I/Os for “hot” content, thus freeing the spinning media disks for data accesses to the long tail content 624.

In this embodiment, a histogram algorithm finds and maps access hot-spots the storage system with a two-level binning strategy and feature vector analysis. For example, in up to 50 TB of useable capacity, the most frequently accessed blocks may be identified so that the top 2% (1 TB) can be migrated to the tier-0 storage. The algorithm computes that stability of both the access to HDD VLUNs and SSD tier-0 storage so that it only migrates blocks when there are statistically significant changes in access patterns. Furthermore, the mapping update design for integration with the virtualization engine allows the mapping to be updated while the system is running I/O. Users can access the hot-spot histogram data and can also specify specific data for lock-down into the tier-0 for known high-access content. This technique is targeted to accelerate I/O for any workload that has an access distribution such as Zipf distribution for VoD content or any PDF (Probability Density Function) that has structure and is not truly uniformly random. In cases where access is truly uniformly random, analysis of the histogram can detect this and provide a notification that the access is random. SSDs are therefore, in such an embodiment, integrated in the controller as a tier-0 storage and not as a replacement for HDDs in the array.

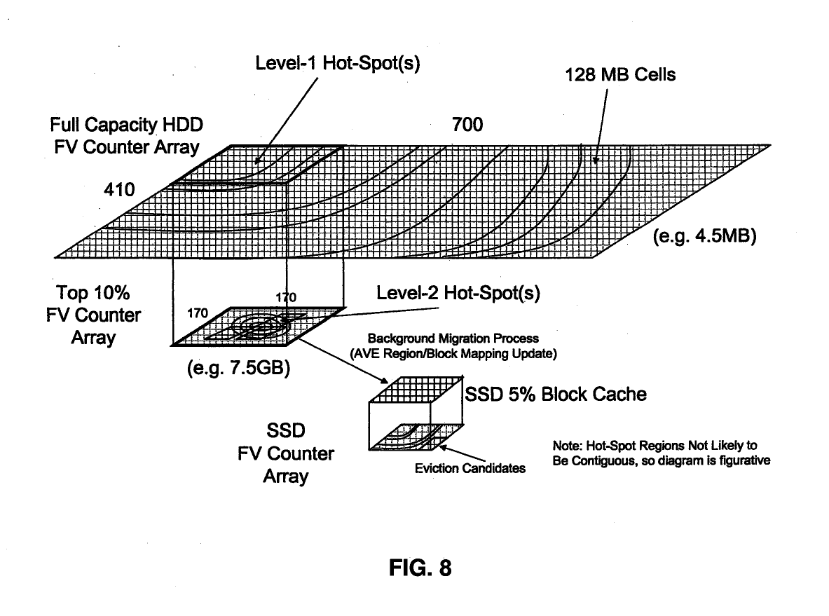

In one embodiment, in-data-path analysis uses an LBA-address histogram with 64-bit counters to track number of I/O accesses in LBA address regions. The address regions are divided into coarse LBA bins (of tunable size) that divide total useable capacity into 128 MB regions (as an example). If the SSD capacity is for example 5% of the total capacity, as it would be for 1 TB of SSD capacity and 20 TB of HDD capacity, then the SSDs would provide a tier-0 storage that replicates 5% of the total LBAs contained in the HDD RAID array. As enumerated below for example, this would require 7.5 GB of RAM-based 64-bit counters (in addition to the 4.48 MB) to track access patterns for useable capacity in excess of 20 TB (up to 35 TB). As shown in FIG. 8, the hot-spots within the highly accessed 128 MB regions would then become candidates for content replication in the faster access SSDs backed by the original copies on HDDs. This can be done with a fine-binned resolution of 8 LBAs per SSD set. For this example:
Useable Capacity Regions
   E.g. (80 TB—12.5%)/2=35 TB, 286720 128 MB Regions (256K LBAs per Region)
Total Capacity Histogram (MB's of Storage)
   64-Bit Counter Per Region
   Array of Structs with {Counter, DetailPtr}
   4.48 MB for Total Capacity Histogram
Detail Histograms (GB's of Storage)
   Top X %, Where X=(SSD_Capacity/Useable_Capacity)×2 Have Detail Pointers
   E.g. 5%, 14336 Detail Regions, 28672 to Oversample
   128 MB/4K=32K 64-Bit Counters
   8 LBAs per SSD Set
   256K Per Detail Histogram×28672=7.5 GB

With the two-level (coarse region level and fine-binned) histogram, feature vector analysis mathematics is employed to determine when access patterns have changed significantly. This computation is done so that the SSD tier-0 storage is not re-loaded too frequently, which may result in thrashing. The math used requires normalization of the counters in a histogram using the following equations:

$$Fv\_Size = \frac{Num\_Bins}{Fv\_Dimension}$$

$$∀ i , {Fv}_{t 1} [ i ] = \frac{{\sum }_{j = ( i ( Fv\_size ) )}^{j < ( i ( Fv\_size ) ) + Fv\_Size} Bin [ j ]}{{Total\_Samples}_{t 1}}$$

$$∀ i , Δ Fv [ i ] = \frac{abs ( {Fv}_{t 2} [ i ] - {Fv}_{t 1} [ i ] )}{2.0}$$

$$Δ Shape = {\sum }_{i = 0}^{i < FV\_Size} Δ {Fv}_{t 2} [ i ] - Δ {Fv}_{t 1} [ i ]$$

### Where:

FV Size=number of counters lumped in dimension
Num Bins=Total counters or number of regions
FV_Dimension=number of elements in vector
Summation of Normalized Histogram taken at epoch t1, |Fv|<1.0
Fv Change between epoch t2 and t1, where |DFv<1.0|
0.0≦ΔShape≦1.0
   ΔFV=0.0 No Shape Change
   ΔFV=1.0 Max Shape Change—Unstable

When the coarse region level histogram changes (checked on a tunable periodic basis) as determined by a ΔShape that exceeds a tunable threshold, then the fine-binned detail regions may be either remapped (to a new LBA address range) when there are significant changes in the coarse region level histogram to update detailed mapping, or when change is less significant, this will simply trigger a shape change check on already existing detailed fine-binned histograms. The shape change computation reduces the frequency and amount of computation required to maintain an access hot-spot mapping significantly. Only when access patterns change distribution and do so for sustained periods of time will re-computation of detailed mapping occur. The trigger for remapping is tunable through the ΔShape parameters and thresholds allowing for control of CPU requirements to maintain the mapping, to best fit the mapping to access pattern rates of change, and to minimize thrashing where blocks replicated to the SSD.

The same formulation for monitoring access patterns in the SSD blocks is used so that blocks that are least frequently accessed out of the SSD are known and identified as the top candidates for eviction from the SSD tier-0 storage when new highly accessed HDD blocks are replicated to the SSD.

When blocks are replicated in the SSD, the region from which they came is marked with a bit setting to indicate that blocks in that region are stored in tier-0. In the example this can be quickly checked by the RAID mapping in the virtualization engine for all I/O accesses. If a region does have blocks stored in tier-0, then a hashed lookup is performed to determine which blocks for the outstanding I/O request are available in tier-0 to an array of 14336 LBA addresses. The hash can be an imperfect hash where collisions are handled with a linked list since the sparse nature of LBAs available in tier-0 makes hash collisions unlikely. If an LBA is found to be in the SSD tier-0 for read, it will be read from the SSD rather than HDD to accelerate access. If an LBA is found to be in the SSD tier-0 for write, then it will be updated both in the SSD tier-0 and HDD backing store (write through). Alternatively, the SSD tier-0 policy can be made write-back on write I/Os and a dirty bit maintained to ensure eventual synchronization of HDD and SSD tier-0 content.

Blocks to be migrated are selected in sets (e.g. 8 LBAs in the example provided) and are read from HDD and written to SSD with region bits updated and detailed LBA mappings added to or removed from the LBA mapping hash table. Before a set of LBAs is replicated in the SSD tier-0 storage, candidates for eviction are marked based on those least accessed in SSD and then overwritten with new replicated LBA sets.

The LBA mapping hash table allows the virtualization engine to quickly determine if an LBA is present in the SSD tier-0 or not. The hash table will be an array of elements, each of which could hold an LBA detail pointer or a list of LBA detail pointers if hashing collisions occur. The size of the hash table is determined by four factors:
1. The amount of RAM that can be devoted to the table. More RAM allows for fewer collisions and therefore a faster lookup.
2. The size of the line of LBAs. A larger line size makes the hash table smaller at the expense of fine granular control over exactly the data that is stored in tier-0. Since many applications use sequential data that is much larger than an LBA size, loss of granularity is not bad.
3. The total number of addressable LBAs for which the tier-0 will operate.
4. The size of the area operating as tier-0 storage.

A reasonable hash table size for a video application, for example, could be calculated starting with the LBA line size. Video, at standard definition MPEG2 rates, is around 3.8 Mbps. The data is typically arranged sequentially on disk. A single second of video at these rates is roughly 400 KB, or around 800 LBAs. At these rates, a line size of 100 LBAs or even 1000 LBAs would make sense. If a 100 LBA line size is used for a 35 TB system, there are 752 million total lines, of which 38 million will be in tier-0 at any given point in time. In such a configuration, 32-bit numbers can be used to address lines of LBAs, so total hash table capacity required would be 3008 Mbytes. A hash table that has 75 million entries would allow for reasonably few collisions with a worst case of about 10 collisions per-entry.

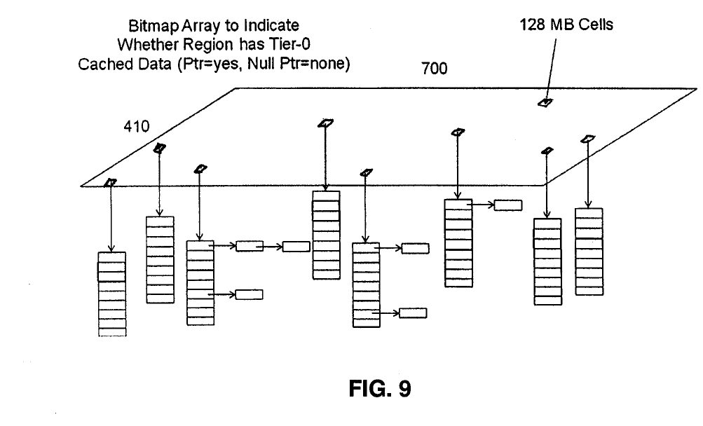

In order to economize on memory usage, the hash table can also be two-leveled like the histogram so that by region LUT (Look Up Table), a single pointer value of non-zero can indicate that this region has LBAs stored in tier-0 and “0” or NULL means it has none. If the region does have hash table for tier-0 LBAs it includes a pointer to the hash table as shown in FIG. 9. If every single region has tier-0 LBAs, this does not require significantly greater overall storage (e.g. 287000 32-bit pointers and a bitmap or approximately 12 MB additional RAM storage in the above example). In cases where many regions have no hash table, then this can eliminate the need to check the hash table for tier-0 LBAs and can save time in the RAID mapping. Likewise, the hash tables could be created per region to save on storage as well as the cost of the time required to do a hash-table check, as illustrated in FIG. 9. Each region that has data in tier-0 would therefore have either an LUT or hash table where an LUT is simply a perfect hash of the LBA address to a look-up index and a hash might have collisions and multiple LBA addresses at the same table index. For an LUT, if each region is 128 MB and line size is 1024 LBAs (or 512K), then each LUT/hash-table would have only 256 entries. In the example shown in FIG. 5, even if every region included a 256 entry LUT, this is only 287,000 256 entry LUTs which would be approximately 73,472,000 LBA addresses which is still only 560 MB of space for the entire two-level table. In this case no hash is required. In general the two-level region based LUT/hash-table is tunable and is optimized to avoid look-ups in regions that contain no LBAs in tier-0. In cases where the LBA line is set small (for highly distributed frequently accessed blocks—more typical of small transaction workloads), then hashing can be used to reduce the size of the LUT by hashing and handling collisions with linked lists when they occur.

In this embodiment, there are two algorithms that could be used to identify LBA regions in the hash table. Each algorithm could have advantages depending on application-specific histogram characteristics, and therefore the algorithm to use may be pre-configured or adjusted dynamically during operation. When switching algorithms dynamically, the hash table is frozen (allowing for continued SSD I/O acceleration during rebuild) and a second hash table is built using the new algorithm (or new table size) and original hash data. Once complete, it is put into production and the original hash table is destroyed. The two hashing algorithms of this embodiment are: (1) A simple mod operation of the LBA region based on the size of the LBA hash table. This operation is very fast and will tend to disperse sequential cache lines that all need to be cached throughout the table. Pattern-based collision clustering can be avoided to some degree by using a hash table size that is not evenly divided into the total number of LBAs, as well as not evenly divisible by the number of drives in the disk array or the number of LBAs in the VLUN stripe size. This avoidance does not come with a lookup time tradeoff. The second algorithm is (2) If many collisions occur in the hash table because of patterns in file layouts, a checksum function such as MD5 can be used to randomize distribution throughout the hash table. This comes at an expense in lookup time for each LBA.

The computational complexity of the histogram updates is driven by the HDD RAID array total capacity, but can be tuned by reducing the resolution of the coarse and/or fine-binned histograms and cache set sizes. As such, this algorithm is extensible and tunable for a very broad range of HDD capacities and controller CPU capabilities. Reducing resolution simply reduces SSD tier-0 storage effectiveness and I/O acceleration, but for certain I/O access patterns reduction of resolution may increase feature vector differences, which in turn makes for easier decision-making for data migration candidate blocks. Increasing and decreasing resolution dynamically, or “telescoping,” will allow for adjustment of the histogram sizes if feature vector analysis at the current resolution fails to yield obvious data migration candidate blocks.

Size of the HDD capacity does not preclude application of this invention nor do limits in CPU processing capability. Furthermore, the algorithm is effective for any access pattern (distribution) that has structure that is not uniformly random. This includes well-known content access distributions such as Zipf, the Pareto rule, and Poisson. Changes in the distribution are “learned” by the histogram while the HDD/SSD hybrid storage system employing this algorithm is in operation.

When lines of LBAs are loaded into the Tier-0 SSDs, the lines are striped over all drives in the Tier-0 set exactly as a dedicated SSD VLUN would be striped with RAID-0 as shown in FIG. 6B. So, a line of LBAs will be divided into strips to span all drives (e.g. a 1024 LBA line mapped to 8 SSDs would map 128 LBAs per SSD). This provides two benefits: 1) all SSDs are kept busy all the time when lines of LBAs are loaded or read and 2) writes are distributed over all SSDs to keep wear leveling balanced over the tier-0.

Another embodiment provides a write-back cache for content ingest. Many applications may not employ threading or asynchronous I/O, which is needed to full advantage of RAID arrays with large numbers of HDD spindles/actuators to generate enough simultaneous outstanding I/O requests to storage so that all drives have requests in their queues. Furthermore, many applications are not well strided to RAID sets. That is, I/O request size does not match well to the strip size in RAID stripes and may also therefore not operate as efficiently as possible. In one embodiment, 2 TB, or 16 SSDs, are used in a cache for 160 HDDs (10 to 1 ratio of HDDs to SSDs) so that the 10× single drive performance of an SSD is well matched by the back-end HDD write capability for well-formed I/O with queued requests. This allows applications to take advantage of large HDD RAID array performance without being re-written to thread I/O or provide asynchronous I/O and therefore accelerates common applications.

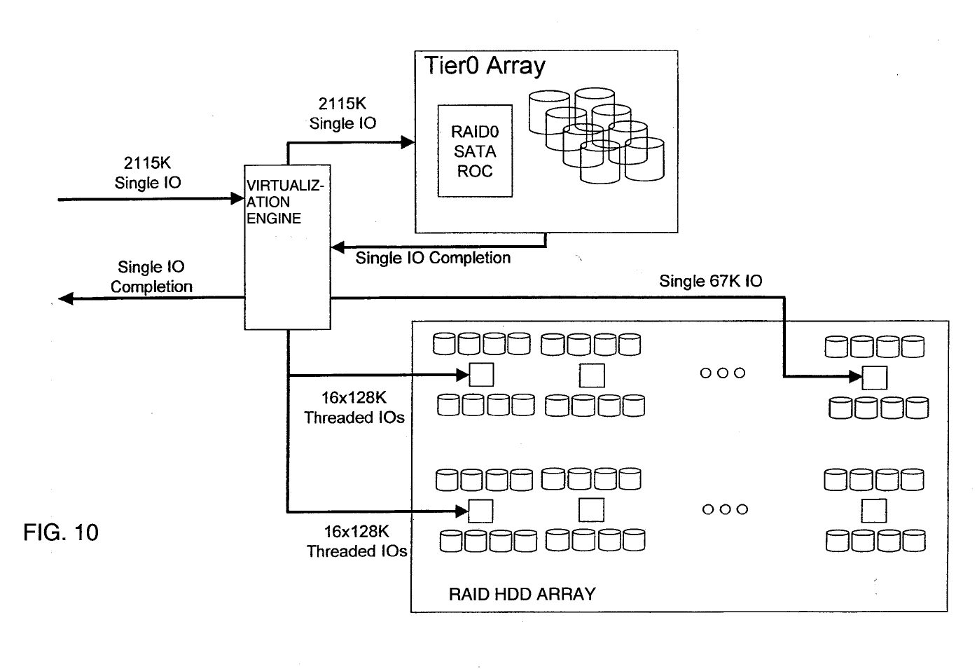

In one embodiment, illustrated in FIG. 10, using an SSD (or other high-performance storage device) write-back cache, these types of applications that have not been tuned for RAID access can be accelerated through the use of the SSD tier-0 for ingest of content. A single threaded initiator with odd-size non-strided I/O requests will make write I/O requests to the SSD tier-0 storage which is significantly lower latency, higher throughput, and with higher I/Os/sec (5 to 10× higher per drive), so that these applications will be able to complete single I/Os more quickly than single mis-aligned I/Os to an HDD. The write-back handling provided by the RAID virtualization engine can then coalesce, reform, and produce threaded asynchronous I/O to the back-end RAID HDD array in an aligned fashion with many outstanding I/Os to improve efficiency for updating the HDD backing store for the SSD tier-0 storage. This will allow total ingest for all I/O request types at rates potentially equal to best-case back end ingest rates. In one embodiment, 2 TB or 16 SSDs might be used in a tier-0 array for 160 HDDs (10 to 1 ratio of HDDs to SSDs) so that the 10× single drive performance of an SSD is well matched by the back-end HDD write capability for well-formed I/O with queued requests. This allows applications to take advantage of large HDD RAID array performance without being re-written to thread I/O or provide asynchronous I/O and therefore accelerates common applications.

This concept was tested for an ingest problem seen on a nPVR (network Personal Video Recorder) head-end application that has single-threaded I/Os of odd size (2115K) that shows poor ingest write performance. With 160 drives striped with RAID-10, the best performance seen with single-threaded 2115K I/Os is 22 MB/sec. With SSD flash drives the ingest performance was improved by 12× up to 269 MB/sec and I/Os reformed with 64 back-end thread writes to the 160 drives to keep up with this new ingest rate. By simply improving the alignment of I/O request size, even single-threaded initiators perform considerably better, which demonstrates the potential speed-up by reforming ingested I/Os to generate multiple concurrent well-strided writes plus a single residual I/O on the back-end. For example, the 2115k I/O becomes 16 concurrent 256 LBA I/Os plus one 134 LBA I/O. Running the same 2115k large I/O with multiple sequential writers, the performance of 76.1 MB/s is improved to over 1 GB/sec. Essentially, the SSD tier ingest provides low latency high throughput for odd sized single-threaded I/Os and reforms them on the back-end to match the improved threaded performance. The process of reforming odd-sized single threaded I/Os is shown in FIG. 10.

Other embodiments herein provide auto-tuning and Mode Learning Features of tier-0. In such embodiments, the tier-0 system includes resolution features that allow the histogram to measure its own performance including: ability to profile access rates of the tier-0 LBAs as well as the main store HDD LBAs and therefore determine if cache line size is too big, ability to learn access pattern modes (access where the feature vector changes, but matches an access pattern seen in the past) using multiple histograms, and the ability to measure stability of a feature vector at a given histogram resolution. These auto-tuning and modal features provide the ability to tune the access pattern monitoring and tier-0 updates so that the tier-0 cache load/eviction rate does not cause thrashing, yet the overall algorithm is adaptable and can “learn” access patterns and potentially several access patterns that may change—for example, in a VoD/IPTV application the viewing patterns for VoD may change as a function of day of the week, and the histogram and mapping along with triggers for tier-0 eviction and LBA cache line loading can be replicated for multiple modes.

Another embodiment improves data access performance through dedicated SSD data digest storage. The tier-0 SSD devices are used to store dedicated 128-bit digest blocks (MD5) for each 512 byte LBA or 4K VLBAs so that SDC (Silent Data Corruption) protection digests don't have to be striped in with VLUN data of the data storage array. In the case of 4K VLBAs, the SSD capacity required is 16/4096, or 0.390625% of the HDD capacity and in the case of 16/512, 3.125% of the HDD capacity.

Data access may also be improved using an extension of histogram analysis to CDN (Content Delivery Network) web cache management. When a file is composed of mostly high access blocks that are cached in tier-0 based upon the above described techniques in a deployment of more than one array (multiple controllers and multiple arrays), the to be cached list can be transmitted as a message or shared as a VLUN such that other controllers in the cluster that may be hosting the same content can use this information as a cache hint. The information is available at a block level, but the hints would most often be at a file level and coupled with a block device interface and a local controller file system. This requires the ability to inverse map blocks to the files that own them which is done by tracking blocks as files are ingested and interfacing to the filesystem inode structure. This allows the block-level access statistics to be translated into file level cache lists that are shared between controllers that host the same files.

In another embodiment, the tier-0 storage may be used for staging top virtual machine images for accelerated replication to other machines. In such an embodiment, images are copied from a virtual machine to other machines connected to a network. Such replication may be useful in many cases where images of a system are replicated to a number of other systems. For example, an enterprise may desire to replicate images of a standard workstation for a class of users to the workstations of each user in that class of user that is connected to the enterprise network. The images for the virtual machines to be replicated are stored in the tier-0 storage, and are readily available for copying to the various other machines.

In still another embodiment, a tier-0 storage provides a performance enhancement when applications perform predictable requests, such as cloning operations. In such cases, there are often long sequences of I/O operations that are monotonic increasing (at a dependable request size). Such patterns are detectable in other scenarios as well, such as Windows drag-and-drop move operations, dd reads, among other operations that are performed a single I/O at a time. In this embodiment, each VLUN will get N number of read-sequence detectors, N being settable based on the expected workload to the VLUN and/or based on the size of the VLUN. Each detector will have a state such as available, searching, locked, depending upon the current state of the read-sequence detector. This design handles interruptions in the sequence and/or interleaved sequences. Interleaved sequences will be assigned to separate detectors and a detector that is locked onto a sequence with interruptions will not be reset unless an aging mechanism on the detector shows that it is the oldest (most stale) detector and all other detectors are locked. The distance of read-ahead (once a sequence is locked) is tunable and, in an embodiment, does not exceed more than 20 MB, although other sizes may be appropriate depending upon the application. For example, if X detectors each use Y megabytes of RAM for Z VLUNs, total RAM consumption of X*Y*Z megabytes would be used and, if X is 10, Y is 20, and Z is 50, the RAM consumption is 10 GB. In other embodiments, a range of addresses are moved to tier-0 storage, and a non-sequential request that may come in is compared against the range of addresses, with further read-ahead operations performed based on the non-sequential request. Another embodiment uses a pool of read-ahead RAM that is used only for the most successful and most recent detectors, and there is a metric for each detector to determine successfulness and age. Note that a failure of the read-ahead system will at worst revert to normal read-from-disk behavior. In such a manner, read requests in such applications may be serviced more quickly.

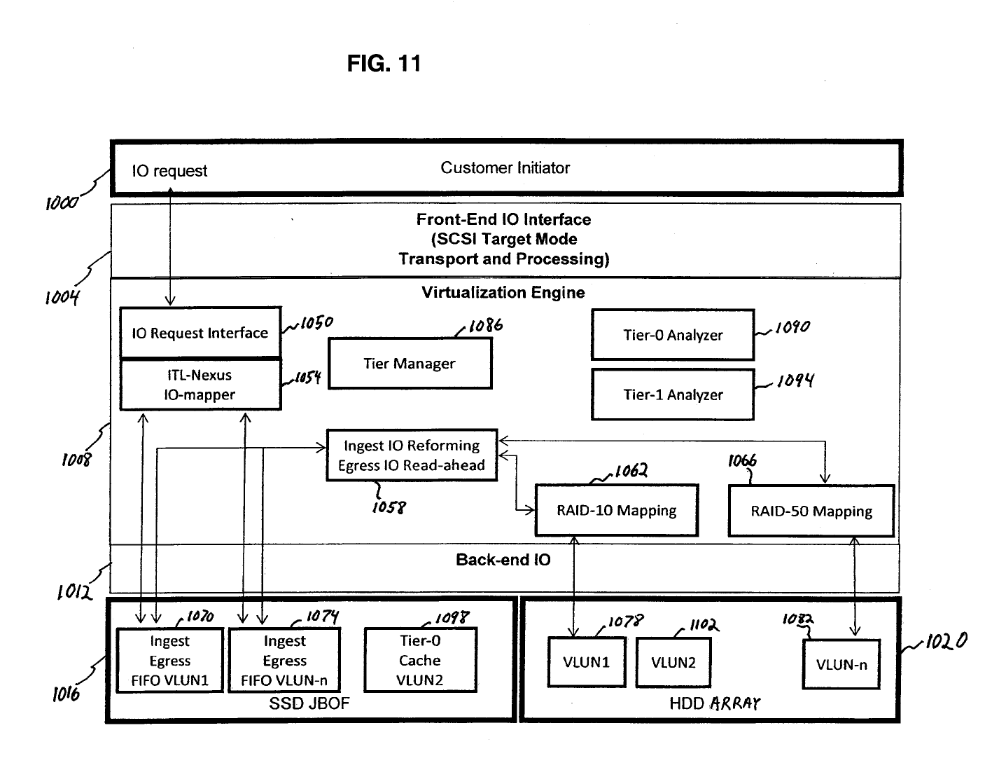

In some embodiments, the system includes initiator-target-LUN (ITL) nexus mapping to further enhance access times for data access. FIGS. 11-15 illustrate several embodiments of this aspect. ITL nexus mapping monitors I/O access patterns per ITL nexus per VLUN. In such a manner, workloads per initiator to each VLUN may be characterized with tier-0 allocations provided in one or more manners as described above for each ITL nexus. For example, for a particular initiator accessing a particular VLUN, tier-0 caching, ingress reforming, egress read-ahead, etc. may be enabled or disabled based on whether such techniques would provide a performance enhancement. Such mapping may be used by a tier manager to auto-size FIFOs and cache allocated per LUN and per ITL nexus per LUN. With reference to FIG. 11, an embodiment is described that provides tiered ingress/egress. In this embodiment, a customer initiator 1000 initiates an I/O request to a front-end I/O interface 1004. A virtualization engine 1008 receives the I/O request from the front-end I/O interface 1004, and accesses, through back-end I/O interface 1012, one or both of a tier-0 storage 1016 and a tier-1 storage 1020. In this embodiment, tier-0 storage 1016 includes a number of SSDs, and tier-1 storage 1020 includes a number of HDDs. The virtualization engine 1008 includes an I/O request interface 1050 that receives the I/O request and an ITL nexus I/O mapper 1054. For a particular ITL nexus, ingest I/O reforming, and egress I/O read-ahead, as described above, is enabled and managed by an ingest I/O reforming and egress I/O read-ahead module 1058. The virtualization engine 1008 provides RAID mapping in this embodiment through a RAID-10 mapping module 1062 and a RAID-50 mapping module. In the example of FIG. 11, initiators are mapped to VLUNs illustrated as VLUN1 1078 and VLUN-n 1082. As mentioned, ingress I/O reforming and egress I/O read-ahead is enabled for these initiators/LUNs, with the tire-0 storage 1016 including an ingest/egress FIFO for both VLUN1 1070 and VLUN-n 1074. When the I/O request is received, the ITL nexus I/O mapper recognizes the initiator/target and accesses the appropriate tier-0 VLUN 1070 or 1074, and provides the appropriate response to the I/O request back to the initiator 1000. The ingest I/O reforming egress I/O read-ahead module maintains the tier-0 VLUNs 1070, 1074 and reads/writes data from/to corresponding VLUNs 1078, 1082 in tier-1 storage 1020 through the appropriate RAID mapping module 1062, 1066.

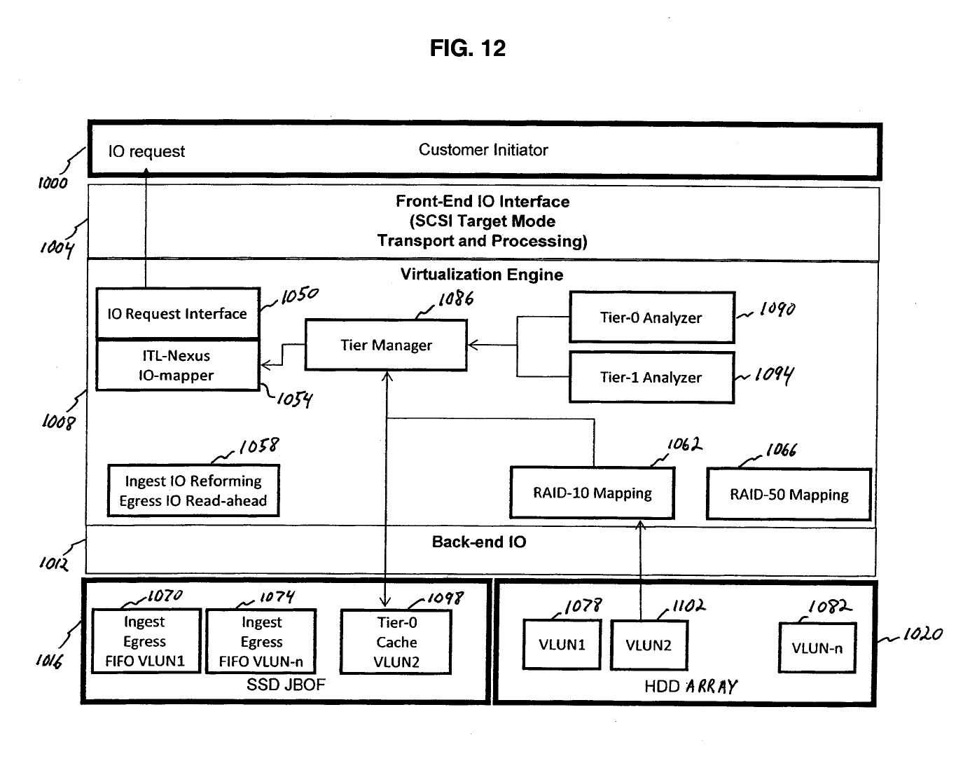

With reference now to FIG. 12, an example of ITL nexus mapping for tier-0 caching is described. In this example, the system includes components as described above with respect to FIG. 11, and the virtualization engine 1008 includes a tier manager 1086, a tier-0 analyzer 1090, and a tier-1 analyzer 1094. The tier manager 1086 and tier analyzers 1090, 1094, perform functions as described above with respect to storage of highly accessed data in tier-0 storage. In this example, the tier-0 storage is used for a particular ITL nexus to provide tiered cache write-back on read. In this embodiment, a read request is received from initiator 1000, and tier manager 1086 identifies that the data is stored in tier-1 storage 1020 at VLUN2 1102. The data is accessed through RAID mapping module 1062 associated with VLUN2, and the data is stored in tier-0 storage 1016 in a tier-0 cache for VLUN2 1098 in the event that the tier analyzers 1090, 1094, indicate that the data should be stored in tier-0.

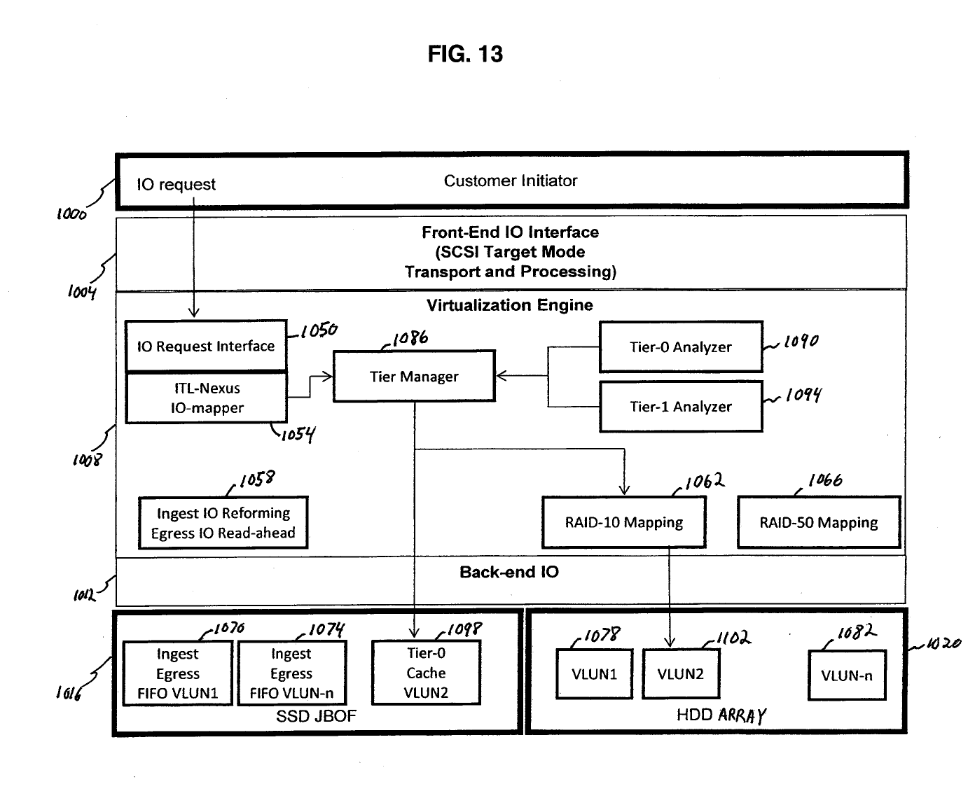

FIG. 13 illustrates tiered cache write-through according to an embodiment for a particular ITL nexus. In this embodiment, a write request is received from an initiator 1000 for data in VLUN2, and the tier manager 1086 writes the data into tier-0 storage at tier-0 cache for VLUN2 1098. The write is reported as complete, and the tier manager provides the data to RAID mapping module 1062 for VLUN2 and writes the data to tier-1 storage 1020 at VLUN2 1102. Tier analyzers 1090 and 1094 perform analysis of the data stored at the different storage tiers

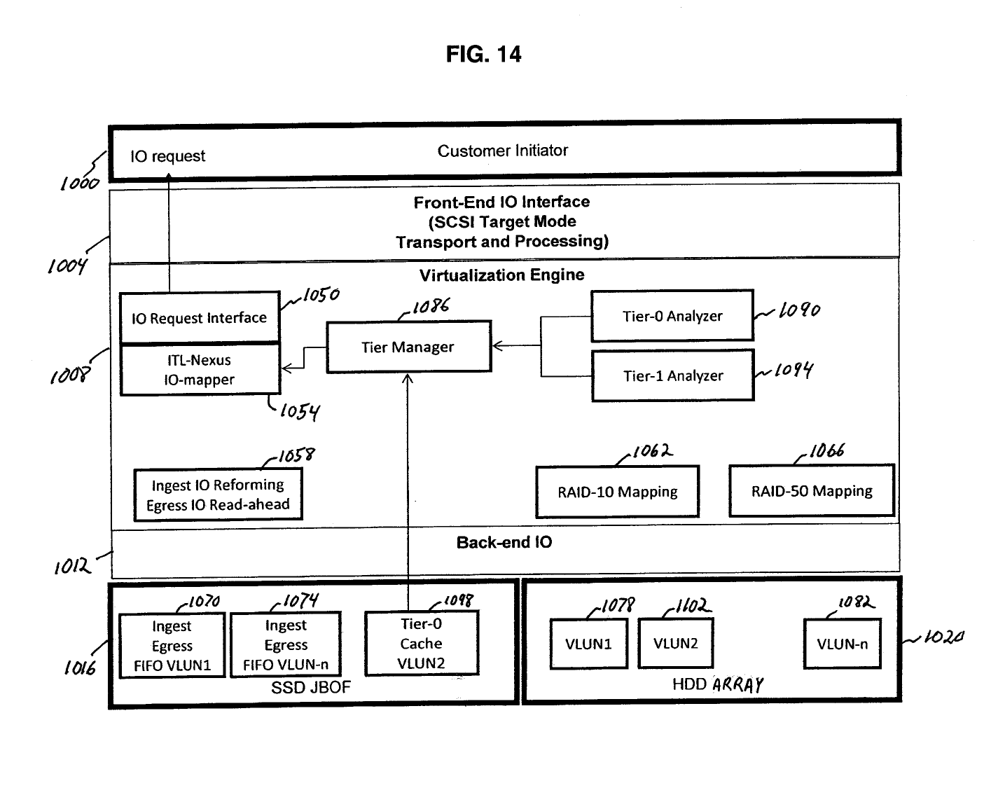

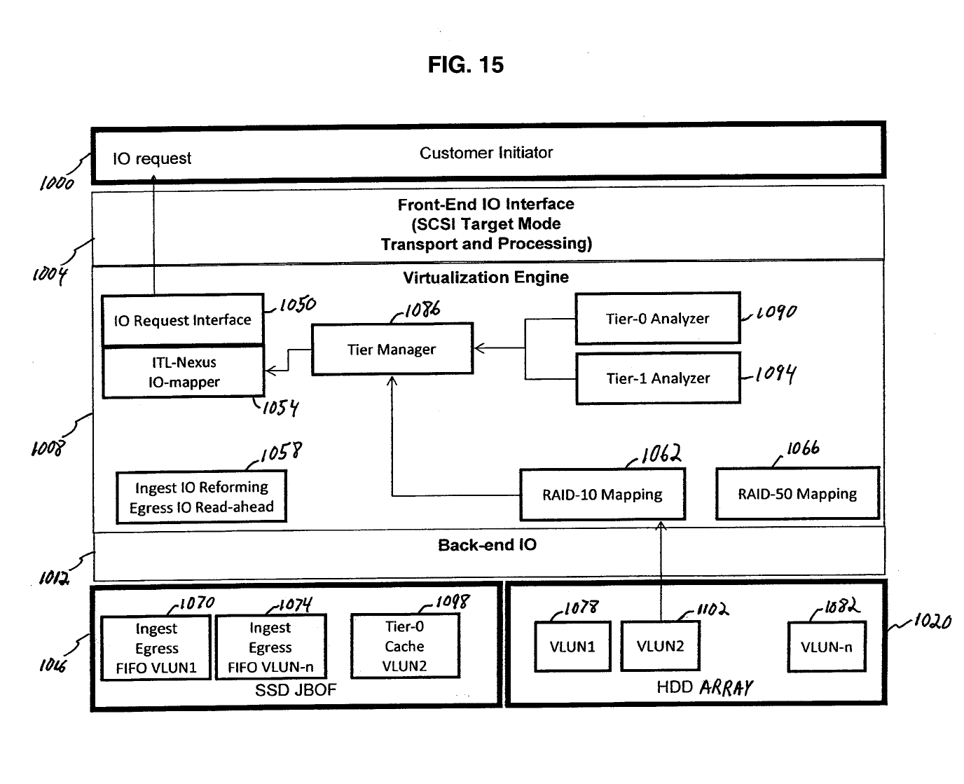

With reference now to FIG. 14, an example is illustrated in which a read-hit occurs for data stored in tier-0 storage 1016. In this example, the virtualization engine 1008 receives a read request from initiator 1000 for a VLUN that has been mapped as a ITL nexus. It is determined by tier manager 1086 if the requested data is stored in the tier-0 cache for the VLUN 1098, and when the data is stored in tier-0 it is provided to the initiator 1000. Referring to FIG. 15, in the event that there is a read miss for tier-0 storage for data requested in an I/O request, the tier manager 1086 accesses the data stored at tier-1 1020 in the associated VLUN 1102 through RAID mapping module 1062.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. If implemented in a software module, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A data storage system, comprising:
a plurality of first storage devices each having a first average access time, said plurality of storage devices having data stored thereon at addresses within said first storage devices;
at least one second storage device having a second average access time that is shorter than said first average access time;
a storage controller that (i) calculates a frequency of accesses to data stored in coarse regions of addresses within said plurality of first storage devices, (ii) calculates a frequency of accesses to data stored in fine regions of addresses within highly accessed coarse regions of addresses, and (iii) copies highly accessed fine regions of addresses to a said second storage device(s).

2. The data storage system as in claim 1, wherein the second average access time is at least half of the first average access time.

3. The data storage system as in claim 1 wherein said plurality of first storage devices comprise a plurality of hard disk drives.

4. The data storage system as in claim 1 wherein said at least one second storage device comprises a solid state memory device.

5. The data storage system as in claim 1 wherein the coarse regions of addresses are ranges of logical block addresses (LBAs) and the number of LBAs in the coarse regions is tunable based upon the accesses to data stored at said first storage devices.

6. The data storage system as in claim 1 wherein the coarse regions of addresses are ranges of logical block addresses (LBAs) and the fine regions of addresses are ranges of LBAs within each coarse region, and the number of LBAs in fine regions is tunable based upon the accesses to data stored in the coarse regions.

7. The data storage system as in claim 1 wherein the storage controller further determines when access patterns to the data stored in coarse regions of addresses have changed significantly and recalculates the number of addresses in said fine regions.

8. The data storage system as in claim 7, wherein feature vector analysis mathematics is employed to determine when access patterns have changed significantly based on normalized counters of accesses to coarse regions of addresses.

9. The data storage system as in claim 7 wherein the storage controller determines when access patterns to the data stored in the second plurality of storage devices have changed significantly and least frequently accessed data are identified as the top candidates for eviction from the second plurality of storage devices when new highly accessed fine regions are identified.

10. The data storage system of claim 1, further comprising a look-up table that indicates blocks in coarse regions that are stored in said second plurality of storage devices.

11. The data storage system of claim 10 wherein the storage controller, in response to a request to access data, determines if the data is stored in said second plurality of storage devices and provides data from said second plurality of storage devices if the data is found in said second plurality of storage devices.

12. The data storage system of claim 10 wherein said look-up table comprises an array of elements, each of which having an address detail pointer.

13. The data storage system of claim 12, wherein said look-up table comprises a two-levels, a single pointer value of non-zero indicating that a coarse region has addresses stored in said second plurality of storage devices and a second address detail pointer.

14. A method for storing data in a data storage system, comprising:
calculating a frequency of accesses to data stored in coarse regions of addresses within a plurality of first storage devices, the first storage devices having a first average access time;
calculating a frequency of accesses to data stored in fine regions of addresses within highly accessed coarse regions of addresses; and
copying highly accessed fine regions of addresses to one or more of a plurality of second storage devices, the second storage devices having a second average access time that is shorter than the first average access time.

15. The method as in claim 14, wherein the second average access time is at least half of the first average access time.

16. The method as in claim 14 wherein the plurality of first storage devices comprise a plurality of identical hard disk drives and the second storage devices comprise solid state memory devices.

17. The method as in claim 14 wherein the coarse regions of addresses are ranges of logical block addresses (LBAs) and the calculating a frequency of accesses to data stored in coarse regions comprises tuning the number of LBAs in the coarse regions based upon the accesses to data stored at the first storage devices.

18. The method as in claim 14 wherein the coarse regions of addresses are ranges of logical block addresses (LBAs) and the fine regions of addresses are ranges of LBAs within each coarse region, and the calculating a frequency of accesses to data stored in fine regions comprises tuning the number of LBAs in fine regions based upon the accesses to data stored in the coarse regions.

19. The method as in claim 14, further comprising:
determining when access patterns to the data stored in coarse regions of addresses have changed significantly, and
recalculating the number of addresses in said fine regions.

20. The method as in claim 19, wherein said determining comprises determining when access patterns have changed significantly based on normalized counters of accesses to coarse regions of addresses.

21. The method as in claim 19 further comprising:
determining that access patterns to the data stored in the second plurality of storage devices have changed significantly;
identifying least frequently accessed data stored in the second plurality of storage devices; and
replacing the least frequently accessed data with data from the first plurality of storage devices that is accessed more frequently.

22. The method of claim 14, further comprising storing identification of the coarse regions that have fine regions stored in the second plurality of storage devices in a look-up table.

23. The method of claim 22 further comprising:
receiving a request to access data;
determining if the data is stored at the second plurality of storage devices; and
providing data from the second plurality of storage devices when the data is determined to be stored at the second plurality of storage devices.

24. The method of claim 22 wherein the look-up table comprises an array of elements, each of which having an address detail pointer.

25. The method of claim 22, wherein the look-up table comprises a two-levels, a single pointer value of non-zero indicating that a coarse region has data stored in the second plurality of storage devices and a second address detail pointer.

26. A data storage system, comprising:
a plurality of first storage devices that have a first average access time and that store a plurality of virtual logical units (VLUNs) of data including a first VLUN;
a plurality of second storage devices that have a second average access time that is shorter than the first average access time; and
a storage controller comprising:
a front end interface that receives I/O requests from at least a first initiator;
a virtualization engine having an initiator-target-LUN (ITL) module that identifies initiators and VLUN(s) accessed by each initiator, and a tier manager module that manages data that is stored in each of said plurality of first storage devices and said plurality of second storage devices,
wherein said tier manager identifies data that is to be moved from said first VLUN to said second plurality of storage devices based on access patterns between said first initiator and data stored at said first VLUN.

27. The data storage system as in claim 26, wherein said virtualization engine further comprises an ingest reforming and egress read-ahead module moves data from said first VLUN to said plurality of second storage devices when said first initiator accesses data stored at said first VLUN, the data moved from said first VLUN to said plurality of second storage devices comprising data that is stored sequentially in said first VLUN relative to said accessed data.

28. The data storage system as in claim 26, wherein said ITL module enables or disables said tier manager for specific initiator/LUN pairs.

29. The data storage system as in claim 27, wherein said ITL module enables or disables said tier manager for specific initiator/LUN pairs, and enables or disables said ingest reforming and egress read-ahead module for specific initiator/LUN pairs.

30. The data storage system as in claim 29, wherein said ITL module enables or disables said tier manager and said ingest reforming and egress read-ahead module based on access patterns between specific initiators and LUNs.

31. The data storage system as in claim 26, wherein said virtualization engine further comprises an egress read-ahead module that moves data from said first VLUN to said plurality of second storage devices when said first initiator accesses data stored at said first VLUN, the data moved from said first VLUN to said plurality of second storage devices comprising data that is stored in said first VLUN in a range of logical block addresses (LBAs) relative to said accessed data.
